(19) United States
(12) Patent Application Publication
(10) Pub. No.: US 2019/0068099 A1
(43) Pub. Date: Feb. 28, 2019

(54) Motor controller and image forming apparatus

(71) Applicant: KONICA MINOLTA, INC., Tokyo (JP)

(72) Inventors: Kazumichi Yoshida, Toyokawa-shi (JP); Yuji Kobayashi, Toyohashi-shi (JP); Harumitsu Fujimori, Toyokawa-shi (JP)

(73) Assignee: KONICA MINOLTA, INC., Tokyo (JP)

(21) Appl. No.: 16/108,277

(22) Filed: Aug. 22, 2018

(30) Foreign Application Priority Data
Aug. 25, 2017 (JP) 2017-161865

(51) Int. Cl. H02P 21/32; H02P 21/18; G03G 15/00

(52) U.S. Cl. CPC H02P 21/32; H02P 6/181; G03G 15/6529; H02P 21/18

(57) ABSTRACT

A motor controller for controlling a brushless DC motor is provided. The motor controller includes a vector control unit configured to perform a sensorless vector control on the brushless DC motor in accordance with an input command value; a storage portion configured to store time-series control target values so that an amount of rotation angle of the brushless DC motor transitions in a same manner as an expected pattern; and a command portion configured to input, to the vector control unit, the control target values serially as the command value.

The entire disclosure of Japanese Patent application No. 2017-161865, filed on Aug. 25, 2017, is incorporated herein by reference in its entirety.

### BACKGROUND

### 1. Technological Field

The present invention relates to a motor controller and an image forming apparatus.

### 2. Description of the Related Art

Image forming apparatuses such as a printer, copier, and multifunction device take a sheet (recording paper) out of a sheet tray, convey the sheet, and print, at a predetermined position, an image onto the sheet that is being conveyed. Such an image forming apparatus has, in its internal paper path, rollers disposed at intervals shorter than the length of the sheet. The image forming apparatus controls rotation drive of the rollers so that the sheet passes each position of the paper path at a predetermined time.

As a drive source for driving the rollers, a brushless DC motor has been used which uses permanent magnets as a rotor. In a vector control in which an alternating current flowing through windings (coils) of the brushless DC motor is controlled as a vector component of a d-q coordinate system, the brushless motor can be rotated smoothly with a high efficiency.

In using a sensorless brushless DC motor, a sensorless vector control is performed in which a position of magnetic poles of a rotor is estimated as a rotational angular position and an alternating current is determined based on the result of estimation.

Conventional technologies for enhancing accuracy of the sensorless vector control include a technology described in Japanese Patent No. 6003924. According to the technology described therein, a torque command value is calculated based on a speed command value, an estimated phase value (position of magnetic poles) of a rotor estimated based on a motor current is corrected in accordance with the torque command value, and the post-correction estimated phase value is used to determine an alternating current.

The accuracy for estimating a position of magnetic poles in the sensorless vector control is lower in a case where a rotational speed of a motor is low than in a case where the rotational speed of the motor is high. For this reason, when the motor in a stopped state is started and accelerated, or, alternatively, when the motor which rotates steadily is decelerated and stopped, an actual value of the rotational speed or a rotational angular position is sometimes substantially different from a target value (command value) thereof.

In an image forming apparatus, the amount of rotation angle of a motor which is involved in conveying a sheet corresponds to a travel distance of the sheet. In light of this, if there is an error in amount of rotation angle of the motor at a time when the sheet reaches a print position, the error causes a position difference between the sheet and an image. This unfortunately degrades the quality of printed matters. Another problem arises when motors for driving two rollers, spaced away from each other in the conveyance direction, are concurrently started or stopped with one sheet contacting the two rollers. In such a case, if there is a difference in transition of an amount of rotation angle between the two motors, the sheet is pulled or pushed to become wrinkled.

The technology described in Japanese Patent No. 6003924 is to increase the accuracy of estimation of a position of magnetic poles. Thus, it is difficult to use the technology described therein to reduce an error in an amount of rotation angle occurring in low-speed rotation where the estimation is substantially impossible.

### SUMMARY

The present invention has been achieved in light of such a problem, and therefore, an object of an embodiment of the present invention is to bring transition of an amount of rotation angle close to desired transition.

To achieve at least one of the abovementioned objects, according to one aspect of the present invention, a motor controller reflecting one aspect of the present invention is a motor controller for controlling a brushless DC motor. The motor controller includes a vector control unit configured to perform a sensorless vector control on the brushless DC motor in accordance with an input command value; a storage portion configured to store time-series control target values so that an amount of rotation angle of the brushless DC motor transitions in a same manner as an expected pattern; and a command portion configured to input, to the vector control unit, the control target values serially as the command value.

### BRIEF DESCRIPTION OF THE DRAWINGS

The advantages and features provided by one or more embodiments of the invention will become more fully understood from the detailed description given hereinbelow and the appended drawings which are given byway of illustration only, and thus are not intended as a definition of the limits of the present invention.

FIG. 1 is a diagram showing an outline of the structure of an image forming apparatus having a motor controller according to an embodiment of the present invention.

FIG. 2 is a diagram showing an example of the structure of a motor controller.

FIG. 3 is a diagram showing an example of a d-q axis model of a motor.

FIG. 4 is a diagram showing an example of the configuration of a vector control unit of a motor controller.

FIG. 5 is a diagram showing an example of the configuration of a motor drive portion and a current detector.

FIG. 6 is a diagram showing an outline of an operation pattern of a motor.

FIGS. 7A-7C are diagrams showing examples of a difference between a target value and an actual value in driving a motor.

FIGS. 8A and 8B are diagrams showing how an error in amount of rotation angle of a motor affects a sheet.

FIG. 9 is a diagram showing a tendency of change in error in amount of rotation angle.

FIG. 10 is a diagram showing an example of the functional configuration of a storage of a motor controller.

FIGS. 11A-11C are diagrams showing an example of the structure of a settings table.

FIGS. 12A-12D are diagrams showing an example as to how to set an initial target speed.

FIG. 13 is a diagram showing an outline of correction to a control target value.

FIG. 14 is a diagram showing an example of correction to a control target value.

FIGS. 15A and 15B are diagrams showing a plurality of aspects of correction to a control target value.

FIG. 16 is a diagram showing another example as to how to set an initial target speed.

FIGS. 17A and 17B are diagrams showing examples as to how to set an initial target speed for each of drive conditions.

### DETAILED DESCRIPTION OF THE EMBODIMENTS

Hereinafter, one or more embodiments of the present invention will be described with reference to the drawings. However, the scope of the invention is not limited to the disclosed embodiments.

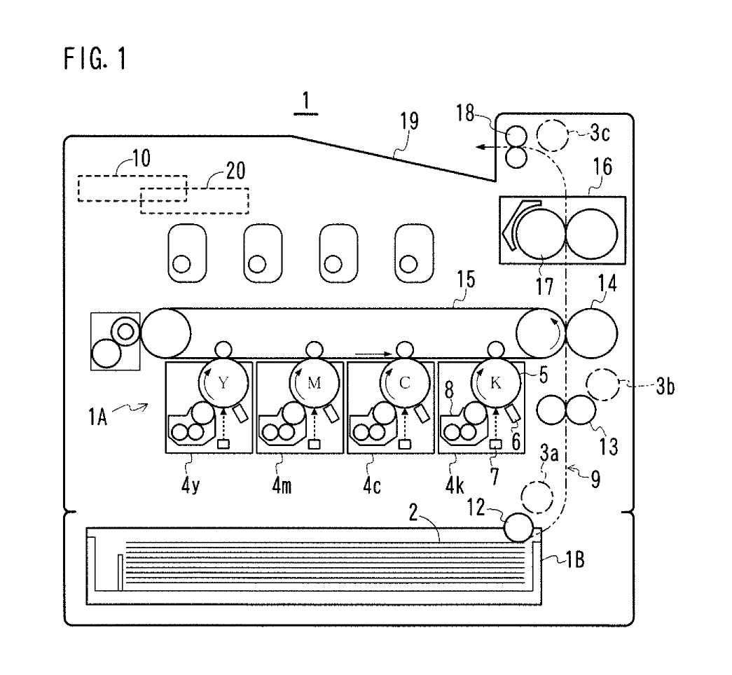

FIG. 1 shows an outline of the structure of an image forming apparatus 1 having a motor controller 20 according to an embodiment of the present invention.

Referring to FIG. 1, the image forming apparatus 1 is a color printer provided with an electrophotographic printer engine 1A. The printer engine 1A has four imaging stations 4y, 4m, 4c, and 4k disposed in the horizontal direction. Each of the imaging stations 4y-4k has a tubular photoconductor 5, an electrostatic charger 6, a print head 7, a developing unit 8, and so on.

In a color printing mode, the four imaging stations 4y-4k form, in parallel, toner images of four colors of yellow (Y), magenta (M), cyan (C), and black (K). The toner images of four colors are primarily transferred to a rotating intermediate transfer belt 15 successively. To be specific, the toner image of yellow (Y) is first transferred to the intermediate transfer belt 15, and then, the toner image of magenta (M), the toner image of cyan (C), and the toner image of black (K) are transferred in this order to cover the toner image of yellow (Y).

The toner images thus primarily transferred are then secondarily transferred onto a sheet (recording paper) 2 which has been taken out of a paper cassette 1B at a time when the toner images face a secondary transfer roller 14. After the secondary transfer, the sheet 2 passes through a fixing unit 16 and then to be delivered to a paper output tray 19. While the sheet 2 passes through the fixing unit 16, the toner image is fixed onto the sheet 2 by application of heat and pressure.

The sheet 2 passes on a paper path 9 provided inside the image forming apparatus 1. In the paper path 9, there are provided, in order from the upstream thereof, a paper feed roller 12, registration rollers 13, the secondary transfer roller 14, fixing rollers 17, and paper output rollers 18. Rotation of the rollers 12-14, 17, and 18 conveys the sheet 2.

The paper feed roller 12 draws out, from the paper cassette 1B, the topmost sheet 2 of sheets loaded therein, and sends out the sheet 2 toward the downstream. The registration rollers 13 are at a stop when the sheet 2 arrives at the registration rollers 13. The registration rollers 13 start running at a time when the positions of the sheet 2 and the toner images primarily transferred onto the intermediate transfer belt 15 are brought into register to each other. The registration rollers 13 then send out the sheet 2 to the secondary transfer roller 14.

The secondary transfer roller 14 adheres the sheet 2 to the intermediate transfer belt 15. The fixing rollers 17 are a pair of rollers provided in the fixing unit 16. The fixing rollers 17 apply heat and pressure to the sheet 2. The paper output rollers 18 serve to output the sheet 2 which has undergone the fixing process to the paper output tray 19.

The image forming apparatus 1 is provided with a plurality of motors 3a, 3b, and 3c serving as rotary drive sources and a motor controller 20 for controlling the motors 3a-3c. The motor 3a is used as a paper feed motor to drive the paper feed roller 12. The motor 3b is used as a registration motor to drive the registration rollers 13. The motor 3c is used as a paper output motor to drive the paper output rollers 18.

Hereinafter, the motors 3a-3d are sometimes referred to as a “motor 3” without being distinguished from one another.

The image forming apparatus 1 is provided with other motors in addition to the motors 3a-3d. Such other motors are, for example, motors for driving the secondary transfer roller 14, the fixing rollers 17, the photoconductors 5, rollers in the developing units 8, and a mechanism for supplying toner to the developing units 8 from a toner bottle, respectively. The motors are also controlled by the motor controller 20.

The motor 3 is a brushless DC motor, namely, a Permanent Magnet Synchronous Motor (PMSM) in which a rotor using permanent magnets rotates. The motor 3 is a sensorless motor. The motor 3 has no Hall element sensor for detecting a position of magnetic poles and no encoder for detecting speed.

A stator of the motor 3 has a U-phase core, a V-phase core, and a W-phase core that are located at electrical angle of 120° intervals from one another, and also has three windings (coils) that are provided in the form of Y-connection, for example. A 3-phase alternating current of U-phase, V-phase, and W-phase is applied to the windings to excite cores in turn, so that a rotating magnetic field is caused. The rotor rotates in synchronism with the rotating magnetic field.

The number of magnetic poles of the rotor may be two, four, six, eight, ten, or more than ten. The rotor may be an outer rotor or an inner rotor. The number of slots of the stator 31 may be three, six, nine, or more than nine.

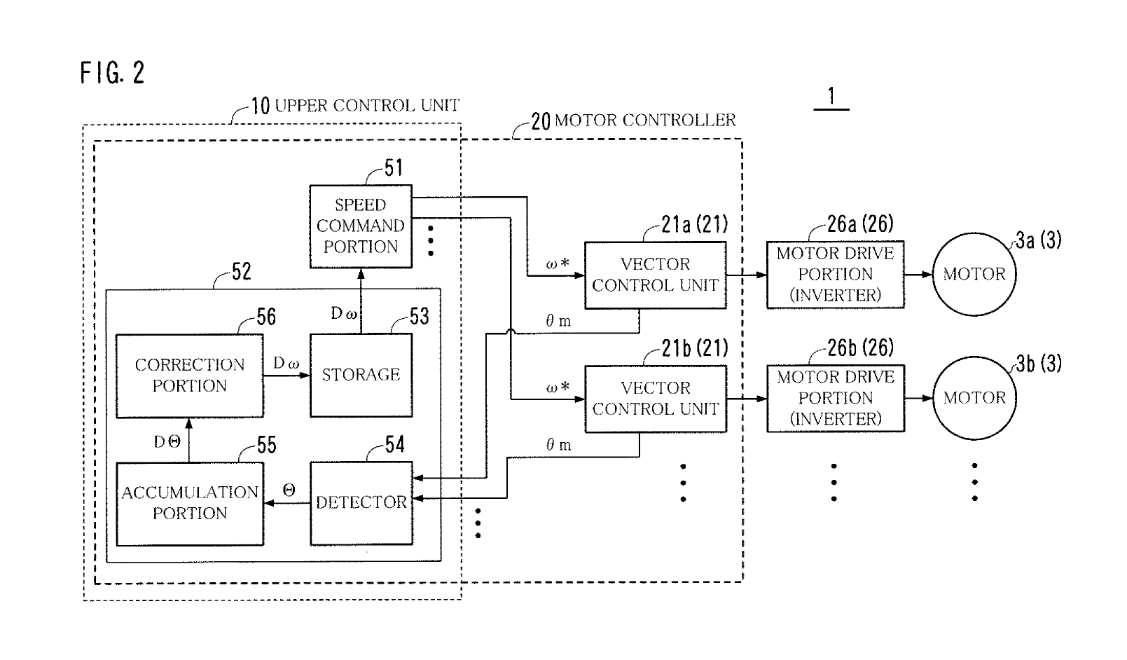

FIG. 2 shows an example of the structure of the motor controller 20. The motor controller 20 shown in FIG. 2 controls the motors 3a-3c (FIG. 1). In FIG. 2, the configuration of parts corresponding to the motors 3a and 3b are shown.

The motor controller 20 is configured of vector control units 21a and 21b, a speed command portion 51, and a target setting block 52. The speed command portion 51 and the target setting block 52 are provided in an upper control unit 10.

The upper control unit 10 is a controller that controls an overall operation of the image forming apparatus 1. The upper control unit 10 is implemented by, for example, a general-purpose Central Processing Unit (CPU) or an Application Specific Integrated Circuit (ASIC) for specific use. The speed command portion 51 and the target setting block 52 are implemented by the hardware configuration of the upper control unit 10. Alternatively, a control program is implemented by a processor, so that the speed command portion 51 and the target setting block 52 are implemented.

The vector control units 21a and 21b perform a sensorless vector control on the motors 3a and 3b, respectively. To be specific, the vector control units 21a and 21b perform a vector control for estimating a position of magnetic poles and a rotational speed by using a control model based on a d-q-axis coordinate system. The vector control unit 21a outputs a control signal to the motor drive portion 26a for driving the motor 3a. The vector control unit 21b outputs a control signal to the motor drive portion 26b for driving the motor 3b.

The vector control units 21a and 21b have the same configuration as each other. Each of the vector control units 21a and 21b functions as a “vector control unit 21”. Further, the motor drive portions 26a and 26b have the same configuration as each other. Thus, the motor drive portions 26a and 26b are sometimes referred to as a “motor drive portion 26” without being distinguished from each other.

The speed command portion 51 gives a speed command to each of the vector control units 21a and 21b. To be specific, the speed command portion 51 obtains, from the target setting block 52, a control target value Dω corresponding to each of the vector control units 21a and 21b, namely, to each of the motors 3a and 3b. The speed command portion 51 then sends the control target value Dω thus obtained to the vector control units 21a and 21b as a speed command value (target speed) ω*.

The target setting block 52 includes a storage 53, a detector 54, an accumulation portion 55, and a correction portion 56. The target setting block 52 receives an input of an estimated angle θm from each of the vector control units 21a and 21b. The functions of these elements of the target setting block 52 are detailed later.

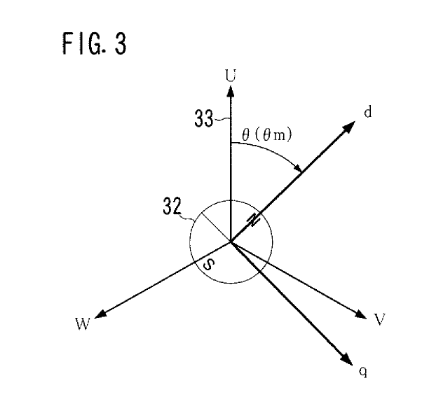

FIG. 3 shows an example of a d-q axis model of the motor 3. The vector control on the motor 3 is simplified by converting the 3-phase alternating current flowing through the windings of the motor 3 to a direct current fed to a 2-phase winding which rotates in synchronism with the rotor.

Let the direction of magnetic flux (direction of a north pole) of the permanent magnet be a d-axis. Let the direction of movement from the d-axis by an electrical angle of π/2[rad] (90°) be a q-axis. The d-axis and the q-axis are model axes. The U-phase winding 33 is used as a reference and an advance angle of the d-axis with respect to the reference is defined as an angle θ. The angle θ represents an angular position of a magnetic pole with respect to the U-phase winding 33, i.e., a magnetic pole position. The d-q-axis coordinate system is at a position advanced, by angle θ, from the reference, namely, the U-phase winding 33.

Since the motor 3 is provided with no position sensor to detect an angular position (position of magnetic poles) of the rotor 32, the vector control unit 21 estimates a position of the magnetic poles of the rotor, namely, the angle θ, and uses the estimated angle θm which is the estimated angle θ to control the rotation of the rotor.

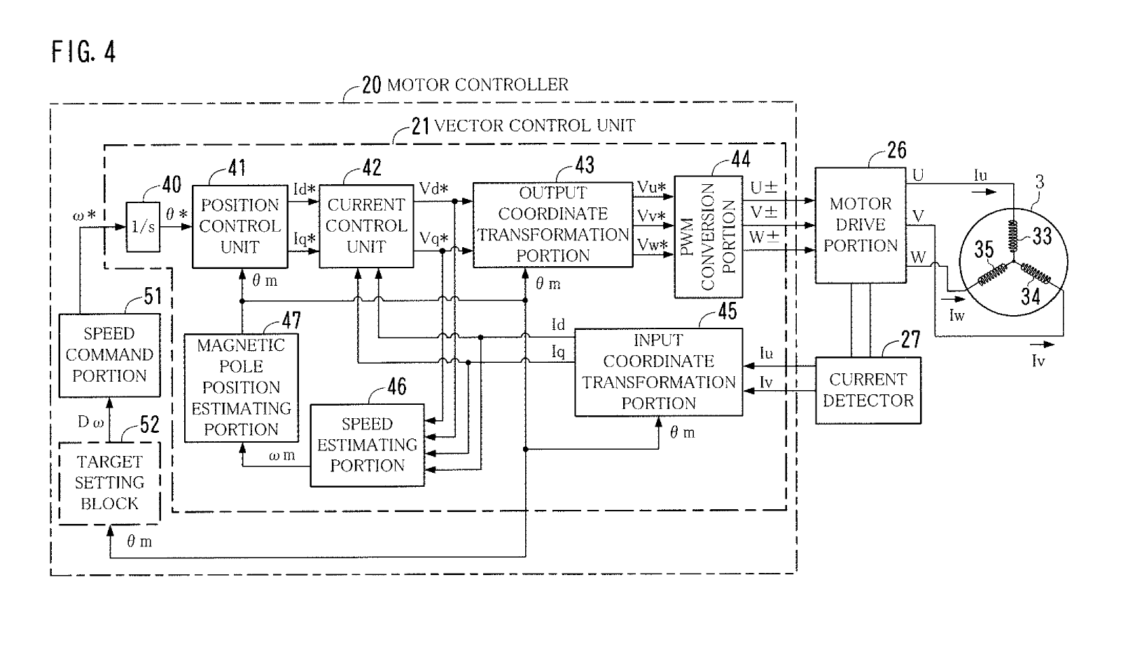

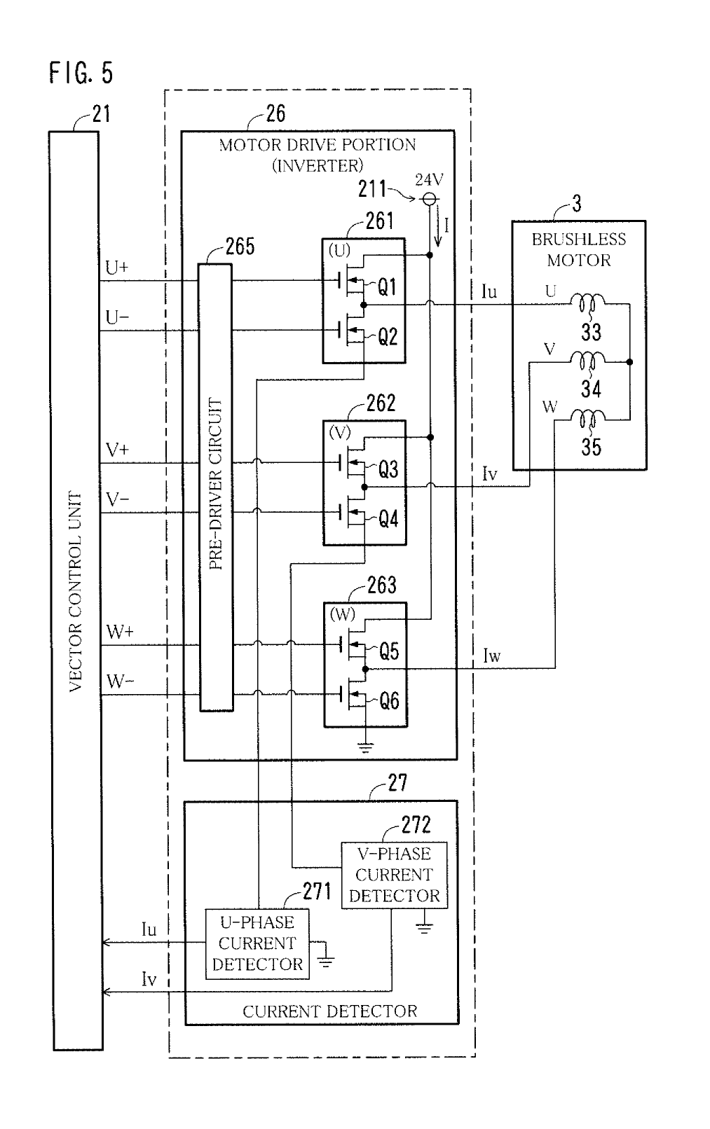

FIG. 4 shows an example of the configuration of the vector control unit 21 of the motor controller 20. FIG. 5 shows an example of the configuration of the motor drive portion 26 and the current detector 27.

Referring to FIG. 4, the vector control unit 21 includes a command conversion portion 40, a position control unit 41, a current control unit 42, an output coordinate transformation portion 43, a PWM conversion portion 44, an input coordinate transformation portion 45, a speed estimating portion 46, and a magnetic pole position estimating portion 47.

The command conversion portion 40 performs integral calculation to convert the speed command value ω*received from the speed command portion 51 to a target position of magnetic poles, namely, an angle command value θ* that indicates a target angle of the rotor. The command conversion portion 40 may be provided in the upper control unit 10.

The position control unit 41 performs operation for a Proportional-Integral control (PI control) of making the difference between the angle command value θ* given by the command conversion portion 40 and the estimated angle θm given by the magnetic pole position estimating portion 47 close to 0 (zero) to determine current command values Id* and Iq* of the d-q-axis coordinate system. The estimated angle θm is inputted periodically. Every time the estimated angle θm is inputted, the position control unit 41 determines the current command values Id* and Iq*.

The current control unit 42 performs operation for a proportional-integral control of making the difference between the current command value Id* and the estimated current value (d-axis current value) Id given by the input coordinate transformation portion 45 close to 0 (zero), and of making the difference between the current command value Iq* and the estimated current value (q-axis current value) Iq given by the input coordinate transformation portion 45 close to 0 (zero). The current control unit 42 then determines voltage command values Vd* and Vq* in the d-q-axis coordinate system.

The output coordinate transformation portion 43 transforms the voltage command values Vd* and Vq* to the U-phase voltage command value Vu*, the V-phase voltage command value Vv*, and the W-phase voltage command value Vw* based on the estimated angle θm given by the magnetic pole position estimating portion 47. In short, the output coordinate transformation portion 43 transforms the 2-phase voltages to the 3-phase voltages.

The PWM conversion portion 44 generates patterns of control signals U+, U−, V+, V−, W+, and W− based on the voltage command values Vu*, Vv*, and Vw* to output the control signals U+, U−, V+, V−, W+, and W− to the motor drive portion 26. The control signals U+, U−, V+, V−, W+, and W− are signals to control, by Pulse Width Modulation (PWM), the frequency and amplitude of the 3-phase alternating power to be supplied to the motor 3.

The input coordinate transformation portion 45 uses the values of the U-phase current Iu and the V-phase current Iv detected by the current detector 27 to calculate a value of the W-phase current Iw. The input coordinate transformation portion 45 then calculates a d-axis current value Id and a q-axis current value Iq that are estimated current values of the d-q axis coordinate system based on the estimated angle θm given by the magnetic pole position estimating portion 47 and the values of the 3-phase currents Iu, Iv, and Iw. In short, the input coordinate transformation portion 45 transforms the 3-phase currents to the 2-phase currents.

The speed estimating portion 46 determines an estimated speed value ωm in accordance with a so-called voltage current equation based on the estimated current values (Id and Iq) given by the input coordinate transformation portion 45 and the voltage command values Vd* and Vq* given by the current control unit 42. The estimated speed value ωm thus determined is then sent to the magnetic pole position estimating portion 47.

The magnetic pole position estimating portion 47 estimates a position of magnetic pole of the rotor 32 based on the estimated speed ωm given by the speed estimating portion 46. To be specific, the estimated speed ωm is integrated to calculate the estimated angle θm. The estimated angle θm thus calculated is inputted to the position control unit 41, the output coordinate transformation portion 43, and the input coordinate transformation portion 45. The estimated angle θm thus calculated is inputted also to the target setting block 52 as information for specifying the amount of rotation angle.

Referring to FIG. 5, the motor drive portion 26 is an inverter circuit for supplying a current to the windings 33-35 of the motor 3 to drive the rotor. The motor drive portion 26 includes three dual elements 261, 262, and 263, and a pre-driver circuit 265.

Each of the dual elements 261-263 is a circuit component that packages therein two transistors having common characteristics (Field Effect Transistor: FET, for example) connected in series.

The dual elements 261-263 control a current I flowing from a DC power line 211 through the windings 33-35 to the ground line. To be specific, transistors Q1 and Q2 of the dual element 261 control a current Iu flowing through the winding 33. Transistors Q3 and Q4 of the dual element 262 control a current Iv flowing through the winding 34. Transistors Q5 and Q6 of the dual element 263 control a current Iw flowing through the winding 35.

The pre-driver circuit 265 converts the control signals U+, U−, V+, V−, W+, and W− fed from the vector control unit 21 to voltage levels suitable for the transistors Q1-Q6. The control signals U+, U−, V+, V−, W+, and W− that have been subjected to the conversion are given to control terminals (gates) of the transistors Q1-Q6.

The current detector 27 detects the currents Iu and Iv flowing through the windings 33 and 34, respectively. Since the relationship of Iu+Iv+Iw=0 is satisfied, the current Iw can be obtained from the calculation of the values of the currents Iu and Iv detected. It is also possible to provide a W-phase current detector.

The current detector 27 amplifies a voltage drop by a shunt resistor provided in the current path of the currents Iu and Iv to perform A/D conversion on the resultant, and outputs the resultant as detection values of the currents Iu and Iv. In short, a two-shunt detection is made. The shunt resistor has a small value ( 1/10Ω order) of resistance.

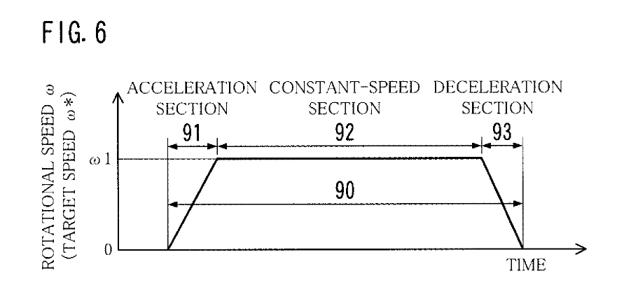

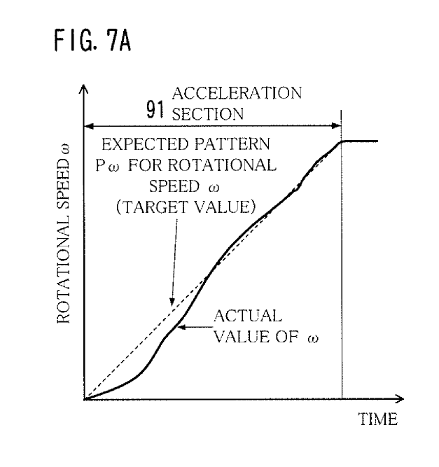

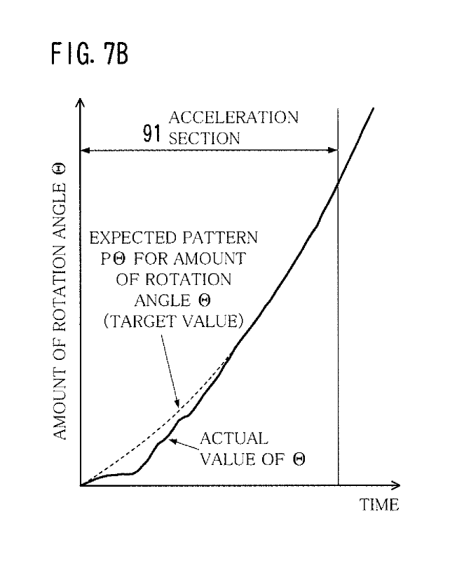

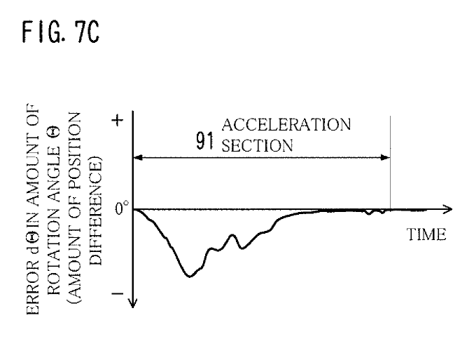

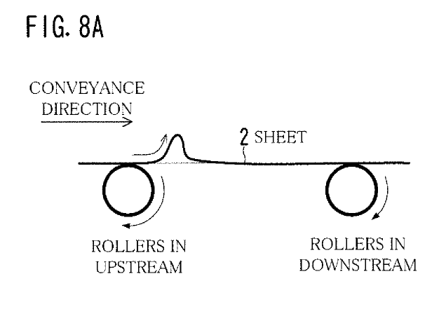

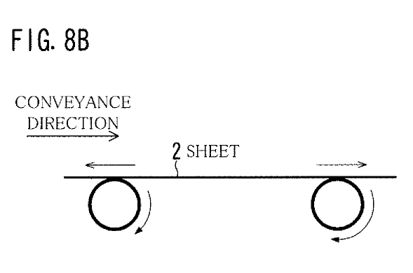

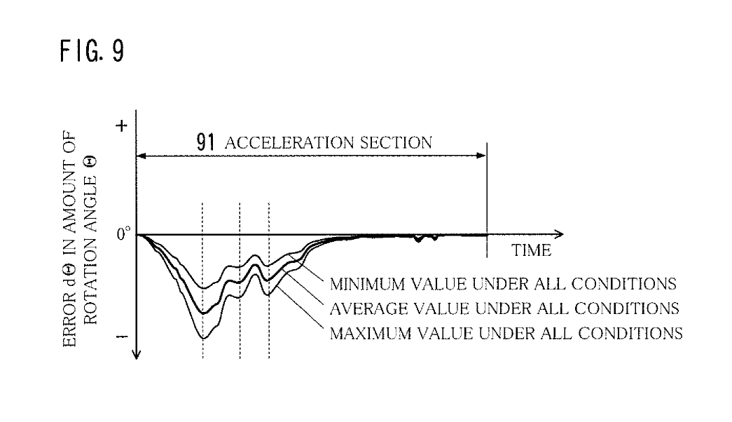

FIG. 6 shows an outline of an operation pattern of the motor 3. FIGS. 7A-7C show examples of a difference between a target value and an actual value in driving the motor 3. FIGS. 8A and 8B show how an error dΘ in amount of rotation angle Θ of the motor 3 affects the sheet 2. FIG. 9 shows a tendency of change in error dΘ in amount of rotation angle Θ.

Referring to FIG. 6, settings of the operation pattern applied to the motor 3, specifically, settings of transition of the rotational speed ω in a motor control period 90 during which the rotation of the motor 3 is controlled, is basically an acceleration/deceleration pattern of a so-called trapezoidal drive. To be specific, the motor 3 starts to drive from a stop state thereof, and accelerates up to a steady speed ω1. The steady speed ω1 is maintained for a predetermined time, and then, the motor 3 decelerates to stop.

A start timing (run timing) of an acceleration section 91, a start timing of a constant-speed section 92, a start timing (start timing of stop-control) of a deceleration section 93, and a finish timing (stop timing) of the deceleration section 93 are preset depending on what is to be driven by the motor 3.

The speed command portion 51 of the motor controller 20 sends, to the vector control unit 21, a speed command value ω* in accordance with the operation pattern. At least, in the acceleration section 91 and the deceleration section 93, the speed command value ω* which increases or decreases as the time passes is inputted at predetermined time intervals. In the constant-speed section 92, one speed command value ω* may be inputted repeatedly. Alternatively, a method may be used in which the vector control unit 21 stores the latest speed command value ω* and the speed command value ω* indicating the steady speed ω1 is inputted only once in the beginning of the constant-speed section 92.

It is desirable that, in the image forming apparatus 1, the rotational speed ω (actual value) of the motor 3 transitions in the same manner as the transition of the speed command value ω* (target value of the rotational speed ω). In practice, however, the target value and the actual value are different from each other as shown in FIG. 7A.

Referring to FIG. 7A, the transition of the target value (expected pattern Pω for the rotational speed ω) is denoted by a dashed line, and the transition of the actual value of the rotational speed ω is denoted by a solid line. In the expected pattern Pω for the rotational speed ω, a pattern corresponding to the illustrated acceleration section 91 is a linear pattern in which the rotational speed ω increases merely at a constant ratio. In contrast, the actual value of the rotational speed ω transitions so as to make a curve. In particular, the accuracy of vector control is low at a low rotational speed ω, so that the actual value substantially deviates from the target value.

If the actual value of the rotational speed ω deviates from the target value thereof, then it necessarily makes a difference between the actual value and the target value of the amount of rotation angle Θ. Referring to FIG. 7B, an expected pattern PΘ for the amount of rotation angle Θ (transition of the target value) is denoted by a dashed line, and the transition of the actual value of the amount of rotation angle Θ is denoted by a solid line. Referring to FIG. 7C, the transition of an error dΘ of the amount of rotation angle Θ, namely, a difference between the target value and the actual value, is shown.

The expected pattern PΘ for the amount of rotation angle Θ corresponds to the expected pattern Pω for the rotational speed ω. To be specific, transition of the angle command value θ* obtained by integrating the speed command value ω* is shown. In the acceleration section 91, the expected pattern Pω for the rotational speed ω is a linear pattern in which the rotational speed ω increases monotonically. Thus, the expected pattern PΘ for the amount of rotation angle Θ is a curve pattern in which the amount of rotation angle Θ increases simply so as to make a simple curve represented in a quadratic function.

In contrast, the actual amount of rotation angle Θ (actual value) transitions to make a complex curve. Stated differently, the transition of the amount of rotation angle Θ deviates from the transition of the expected pattern PΘ for the target value of the amount of rotation angle Θ. In particular, at the time of low speed rotation immediately after the motor 3 starts running, a large error dΘ occurs in amount of rotation angle Θ.

In the vector control unit 21, however, an error dΘ in amount of rotation angle Θ becomes almost zero in the latter half of the acceleration section 91. This is because the PI control is performed to reduce the difference between the angle command value θ* and the estimated angle θm close to zero, and also because the accuracy of speed estimation is high in a time except for low-speed rotation.

Even in the PI control where the difference between the speed command value ω* and the estimated speed value ωm is reduced to close to zero without calculation of the angle command value θ*, the error dΘ in amount of rotation angle Θ possibly becomes zero in the latter half of the acceleration section 91, as shown in FIG. 7C, depending on the transition of the rotational speed ω.

In the motor 3 related to conveyance of the sheet 2, the amount of rotation angle Θ corresponds to a conveyance distance of the sheet 2. The error dΘ in amount of rotation angle Θ causes a position difference of the sheet 2 in the paper path 9. This affects the quality of printed matters.

Where the error dΘ in amount of rotation angle Θ remains at the formation of an image in the sheet 2, a position difference in the conveyance direction occurs between the sheet 2 and the image. Even before or after the image is formed in the sheet 2, the error dΘ in amount of rotation angle Θ becomes a problem, for example, when one sheet 2 contacts two rollers spaced away from each other in the conveyance direction as shown in FIGS. 8A and 8B.

Referring to FIG. 8A, the amount of rotation angle Θ of the motor 3 for driving rollers in the downstream is smaller than the target value. Stated differently, conveyance in the downstream is late. Accordingly, the rollers of the upstream push the sheet 2 excessively, which warps or wrinkles sheet 2.

Contrary to the case of FIG. 8A, referring to FIG. 8B, the amount of rotation angle Θ of the motor 3 for driving rollers in the upstream is smaller than the target value. Stated differently, conveyance in the upstream is late. Accordingly, the rollers of the upstream pull the sheet 2, which applies a stress to the sheet 2 and the rollers in the downstream.

In the meantime, it is probable that the error dΘ in amount of rotation angle Θ is related to the magnitude of an inertial load and a friction load of the motor 3 that depend on the individual difference of the motor 3 and variations in thickness of the sheet 2. In the light of this, the error dΘ was measured by driving the motor 3 under different conditions where the magnitude of an inertial load and a friction load of the motor 3 seems to be slightly different. The different conditions were, for example, as follows: the motors 3 having the same model number were switched for use; or various types of sheet having a basis weight similar to each other were used in order. Consequently, it was found out that, as shown in FIG. 9, the magnitude of the error dΘ is different depending on conditions; however, the transition of the error dΘ has a similar tendency irrespective of the conditions. For example, a time at which the error dΘ becomes a largest value is almost the same in the different conditions.

In short, the transition of the error dΘ is similar to one another in assumed conditions. This means that, if the amount of rotation angle Θ is corrected to reduce the error dΘ in any of conditions (conditions A), the error dΘ can be reduced to some extent even if conditions for the actual use are different from the conditions A.

Based on the findings, the motor controller 20 of this embodiment has a function to approximate the transition of the amount of rotation angle Θ to a desired transition. Hereinafter, the configuration and operation of the motor controller 20 are described, focusing on the function.

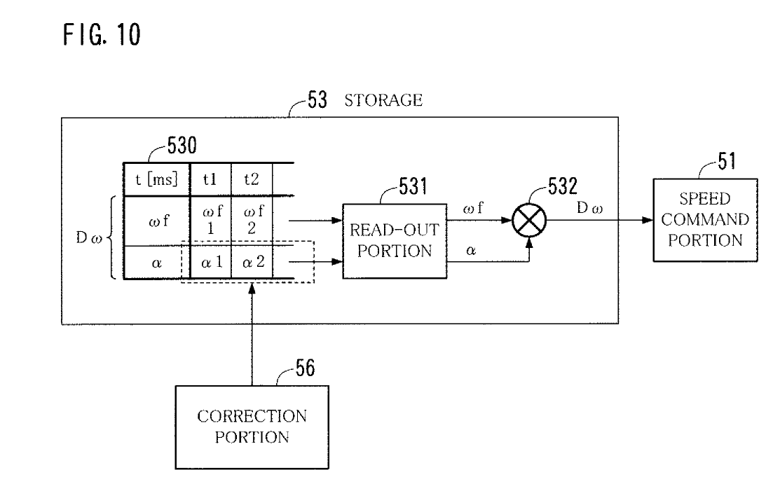

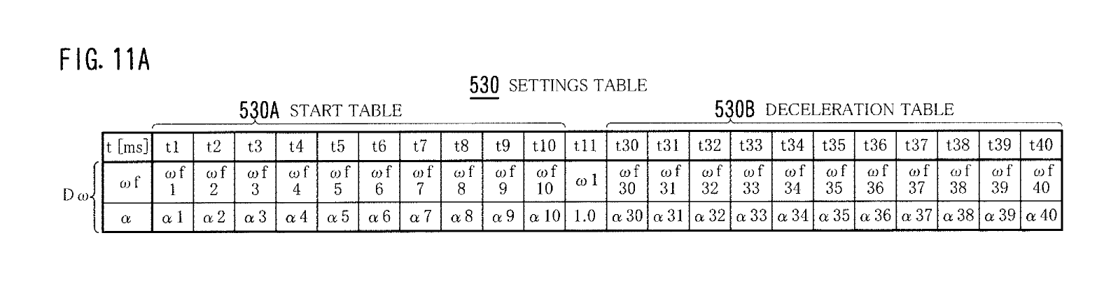

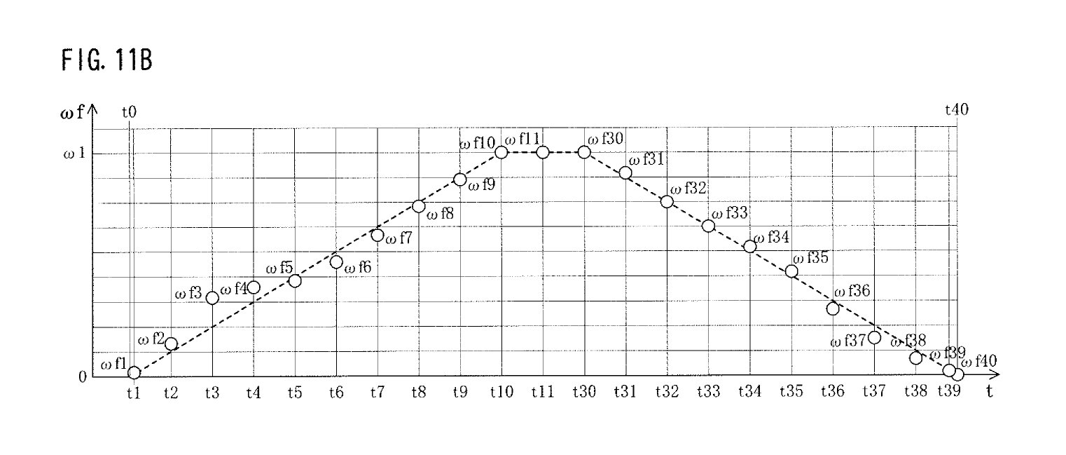

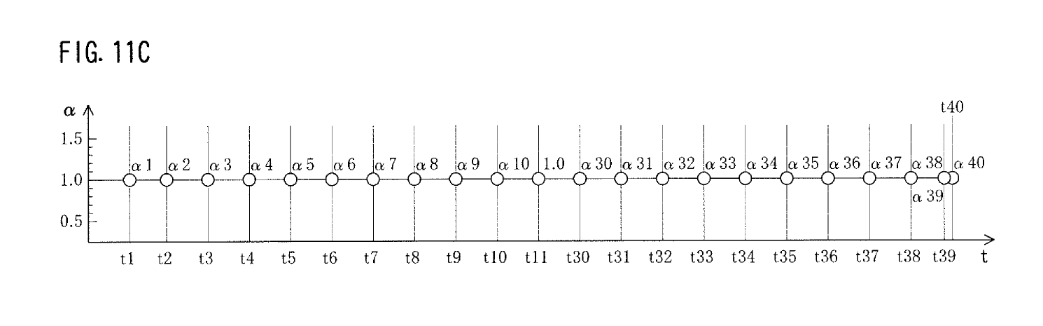

FIG. 10 shows an example of the functional configuration of the storage 53 of the motor controller 20. FIGS. 11A-11C show an example of the structure of a settings table 530.

Referring back to FIG. 2, the motor controller 20 includes the target setting block 52 as a functional block to approximate the transition of amount of rotation angle Θ to a desired transition.

Referring to FIG. 10, the storage 53 of the target setting block 52 includes a settings table 530, a read-out portion 531, and a multiplier 532.

The settings table 530 stores, therein, time-series control target values Dω so that the amount of rotation angle Θ of the motor 3 transitions in accordance with the expected pattern PΘ. In other words, the settings table 530 stores, therein, time-series control target values Dω that, when the vector control is performed based on the control target values Dω, transition in accordance with the expected pattern PΘ. In this embodiment, as the control target value Dω, a set of initial target speed ωf and correction coefficient α is stored.

As shown in FIG. 11A, the control target values Dω are stored, in the form of table, so as to be correlated with the order that the control target values Dω are inputted to the vector control unit 21. In the settings table 530, the input order of the control target values Dω to the vector control unit 21 is represented as an elapsed time t since the motor 3 starts running.

In the example of FIGS. 11A-11C, the elapsed times t1-t10 correspond to the acceleration section 91, the elapsed time t11 corresponds to the constant-speed section 92, and the elapsed times t30-t40 correspond to the deceleration section 93. Stated differently, the settings table 530 includes a start table 530A that indicates the control target values Dω at the acceleration from the start of the motor 3 to the steady rotation thereof, and a deceleration table 530B that indicates the control target values Dω at the deceleration from the steady rotation of the motor 3 to the stop thereof.

The control target value Dω consists of an initial target speed ωf and a correction coefficient α. The initial target speeds ωf are the initial values of the speed command values ω* serially inputted to the vector control unit 21. Prior to shipment of the image forming apparatus 1, the initial target speeds ωf are stored into a non-volatile memory of the storage 53.

The initial target speeds ωf are determined, by trial and error, based on actual measured values of the error dΘ in the production step of the image forming apparatus 1, namely, in a state of no aged deterioration, so that the amount of rotation angle Θ transitions in the same manner as the expected pattern PΘ of FIG. 7B as much as possible. In FIG. 11B, the dashed line represents an expected pattern Pω of a rotational speed ω corresponding to the expected pattern PΘ of FIG. 7B.

The principle of settings for the initial target speed ωf is to set in such a manner that, when an actual value of the amount of rotation angle Θ has a negative error dΘ smaller than the target value, the initial target speed ωf is a relatively higher as the absolute value of the error dΘ is larger. In contrast, when an actual value of the amount of rotation angle Θ has a positive error dΘ larger than the target value, the initial target speed ωf is a relatively lower as the absolute value of the error dΘ is larger. As a general rule, the initial target speeds ωf set and stored remain unchanged.

The correction coefficients α of the control target value Dω are provided as parameters for correcting the speed command values ω* in accordance with the aged deterioration of the image forming apparatus 1 in order to cope with a situation where the error dΘ possibly becomes large if the initial target speed ωf remains unchanged.

As shown in FIG. 11C, values of the correction coefficients α before shipment, namely, the initial values of the correction coefficients α, are uniformly “1.0” for the elapsed times t1-t40. According to the settings table 530 before shipment, the initial target speed ωf is substantially used as the control target value Dω.

The correction coefficients α are automatically reviewed when a preset correction time is reached. The correction portion 56 modifies the correction coefficients α if necessary. When the correction coefficients α are modified to a value different from the initial value, the control target value Dω is corrected to a value different from the initial target speed ωf.

Referring back to FIG. 10, the read-out portion 531 of the storage 53 counts an elapsed time t since the motor 3 started running, sequentially reads out, from the settings table 530, the initial target speeds ωf and the correction coefficients α correlated with the elapsed times t1-t11 and t30-t40 thus counted, and sends the initial target speeds ωf and the correction coefficients α to the multiplier 532.

The multiplier 532 multiplies the initial target speed ωf and the correction coefficient α together, and sends the resulting product as the control target value Dω to the speed command portion 51. The control target value Dω sent to the speed command portion 51 is inputted to the vector control unit 21 as the speed command value ω* as described above.

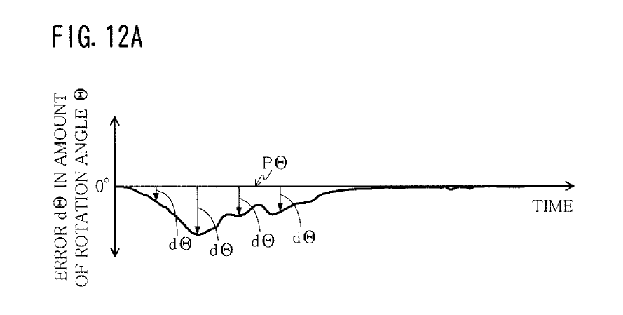

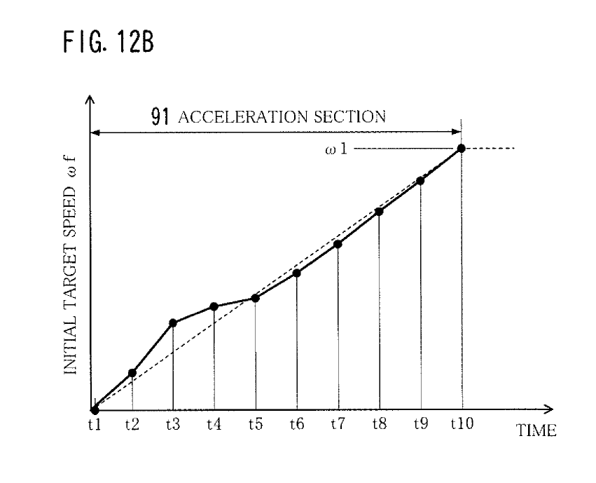

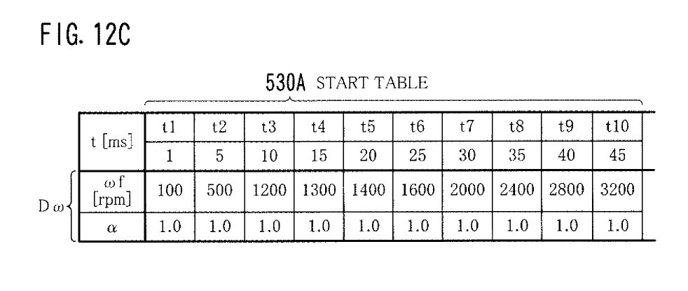

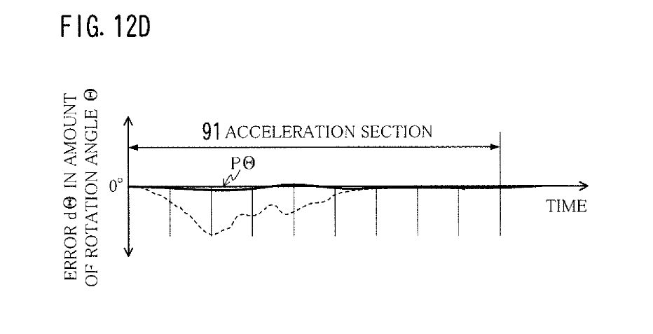

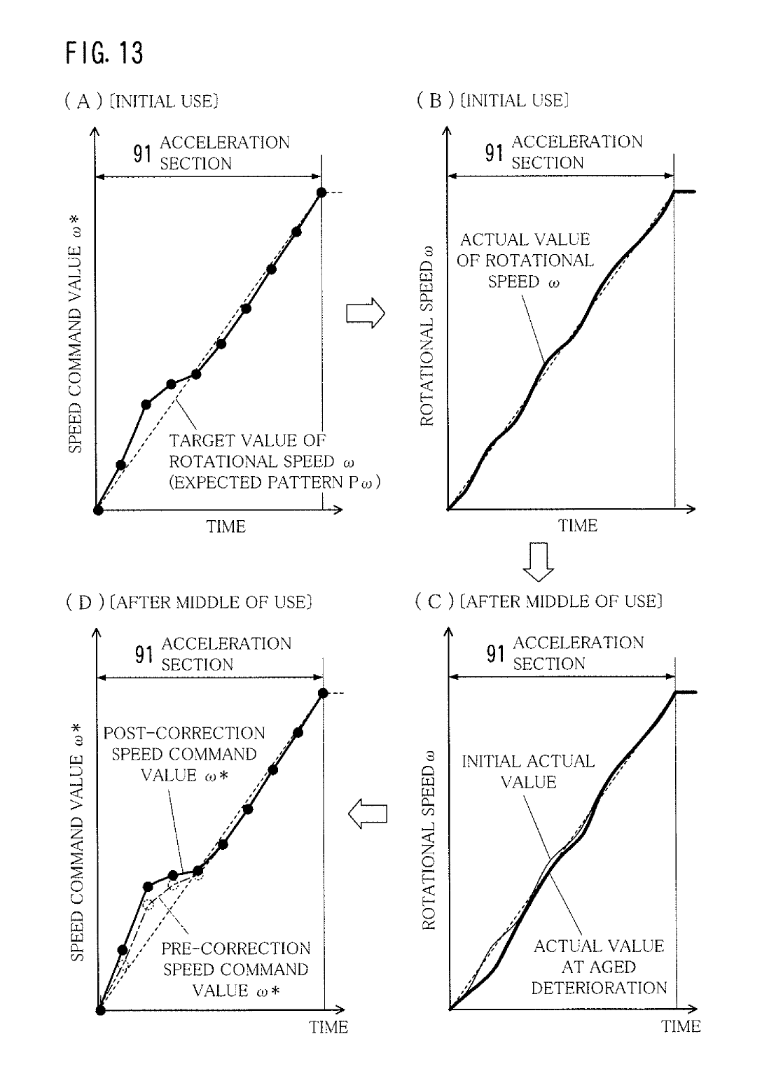

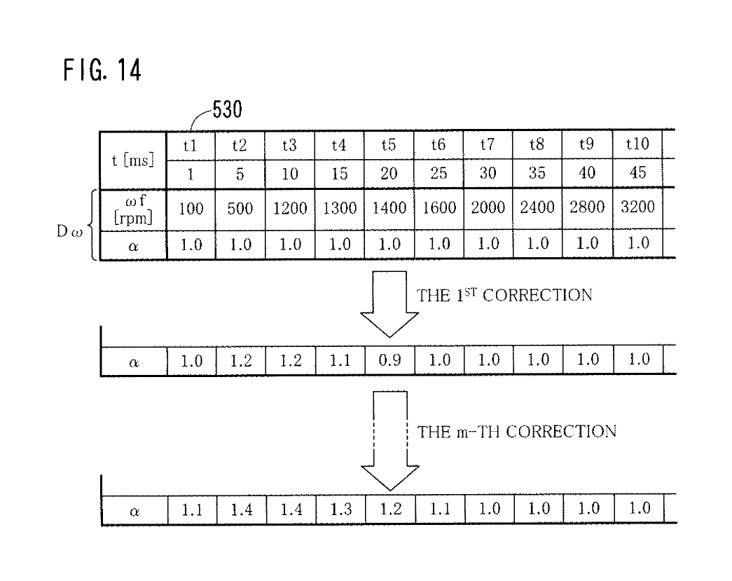

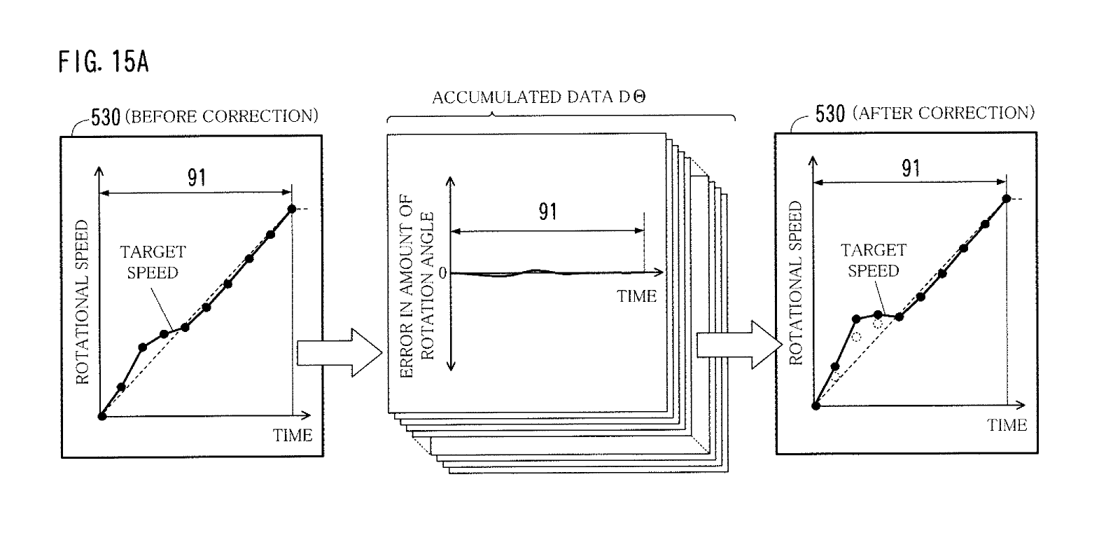

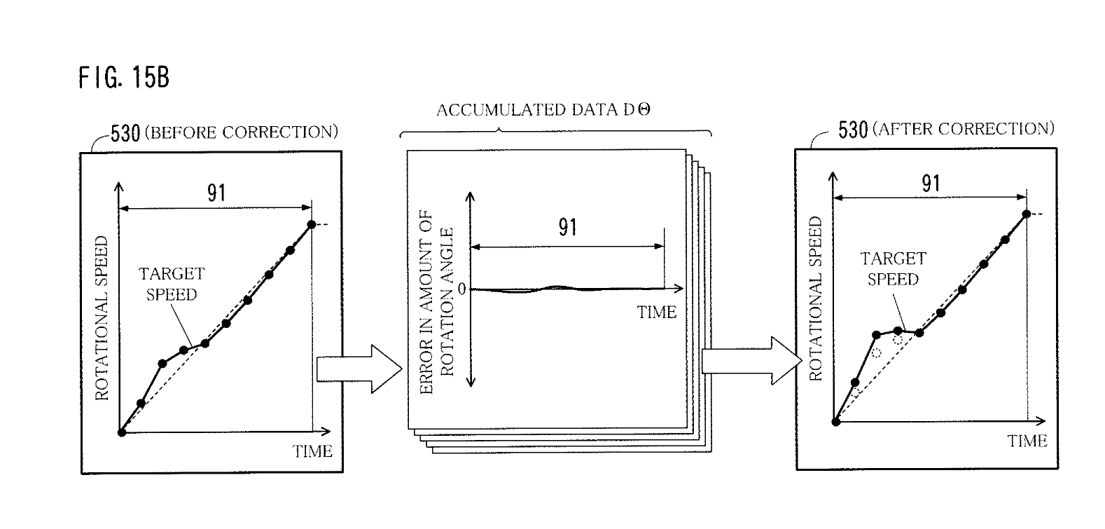

FIGS. 12A-12D show an example as to how to set an initial target speed ωf. FIG. 13 shows an outline of correction to the control target value Dω. FIG. 14 shows an example of correction to the control target value Dω. FIGS. 15A and 15B show a plurality of aspects of correction to the control target value Dω.

In the illustrated example of FIGS. 12A-12D, the steady speed ω1 is 3200 rpm as shown in FIG. 12C. If transition of the initial target speed ωf is set to be the same as the expected pattern (linear pattern) for the rotational speed ω, then an error dΘ occurs as shown in FIG. 12A. To address this, the initial target speed ωf is set as shown in FIGS. 12B and 12C. This enables reduction in error dΘ in amount of rotation angle Θ as shown in FIG. 12D.

To be specific, the speed command value ω* to be inputted to the vector control unit 21 is so set to intentionally deviate from the expected pattern Pω as shown in (A) of FIG. 13. Thereby, the actual value of the rotational speed ω transitions close to desired transition as shown in (B) of FIG. 13 in a stage where a cumulative use time of the image forming apparatus 1 by the user is short, namely, in the initial use of the image forming apparatus 1. This necessarily causes the actual value of the amount of rotation angle Θ to transition almost as desired.

However, in a stage where the cumulative use time of the image forming apparatus 1 is long, namely, after the middle of use of the image forming apparatus 1, the actual value of the rotational speed ω substantially deviates from a desired value thereof as shown in (C) of FIG. 13. To address this, the motor controller 20 changes the speed command value ω* as shown in (D) of FIG. 13 so that the actual value of the amount of rotation angle Θ transitions as desired again.

Referring back to FIG. 2, the detector 54, the accumulation portion 55, and the correction portion 56 of the target setting block 52 are elements provided in order to correct the control target value Dω depending on the aged deterioration of the image forming apparatus 1.

When motor drive to start and then stop the motor 3 is performed, the detector 54 detects transition of the amount of rotation angle Θ after the motor 3 is started. To be specific, every time the latest estimated angle θm is inputted from the vector control unit 21, the detector 54 adds up the amounts of rotation angle Θ to store the same in time series. Storing the amounts of rotation angle Θ in time series corresponds to detection of transition thereof.

As the processing for adding up the amounts of rotation angle Θ, the detector 54 calculates a total amount Σdθ represented by, for example, the following equation.

Σdθ=(360°−θm1)+360°×n+θm2

wherein θm1 represents an estimated angle θm at the start of adding up; θm2 represents the current (latest) estimated angle θm; and n represents a count value of the number of times when the estimated angle θm becomes 0 (zero) or is reduced. The total amount Σdθ corresponds to a value obtained by multiplying a number of rotations N of increments smaller than 1 and an amount of angle (360°) per one rotation together.

The detector 54 detects transition of the amount of rotation angle Θ also at idle drive for rotating the motor 3 without conveying the sheet with the rollers, e.g., at image stabilizing processing or warming up. In the detection at the idle drive, the detector 54 can detect an error dΘ in amount of rotation angle Θ primarily due to aged deterioration in inertial load of the motor 3.

The accumulation portion 55 accumulates data DΘ which indicates the transition of the amount of rotation angle Θ detected by the detector 54. The data DΘ may be the amounts of rotation angle Θ in time series. Alternatively, the data DΘ may be data indicating, in time series, errors dΘ in amount of rotation angle Θ with respect to the expected pattern PΘ (see FIGS. 7A-7C).

In the accumulation of the data DΘ, it is possible to store all the transition of the amounts of rotation angle Θ which has been detected before the settings table 530 was corrected. Where the memory capacity is limited, it is possible to reduce the accumulation so that the number of accumulated sets of data DΘ is smaller than the number of times that transition of the amount of rotation angle Θ has been detected.

Where the transition of the amounts of rotation angle Θ which has been detected deviates from the expected pattern PΘ, the correction portion 56 corrects a plurality of control target values Dω stored in the settings table 530 so that the amounts of rotation angle Θ after the start of the motor 3 transition in the same manner as the expected pattern PΘ. At this time, as the correction to the control target value Dω, the correction coefficients α are modified as shown in FIG. 14. For example, the correction coefficient α at a time (t3) when the error dΘ becomes large is modified from 1.0 to 1.2. When the error dΘ becomes large again due to the later aged deterioration, the correction coefficient α is modified to be a value larger than 1.2.

The correction portion 56 corrects the control target value Dω when a preset correction time is reached. As the correction time, it is possible to set, for example, every time the number of start times of the motor 3 (once, . . . , 10 times, . . . , 100 times . . . ), the total drive hour of the motor 3 (10 hours, . . . , 50 hours, . . . , 100 hours, . . . ), or operation days of the image forming apparatus 1 (1 month, . . . , 1 year, . . . ) exceeds a set value. The set value is selected, anticipating a time at which an error dΘ in amount of rotation angle Θ is expected to be visible.

Referring to FIGS. 15A and 15B, the correction portion 56 corrects the control target values Dω based on the data DΘ accumulated in the accumulation portion 55. As shown in FIG. 15A, it is possible to use all the sets of data DΘ accumulated after the previous correction. Alternatively, as shown in FIG. 15B, it is possible to use only a constant sets of data DΘ resulting from the reduction in sets of data DΘ.

The correction portion 56 determines a post-correction value of the correction coefficient α in accordance with a predetermined algorithm such as averaging the accumulated data DΘ or extracting data DΘ of transition observed frequently.

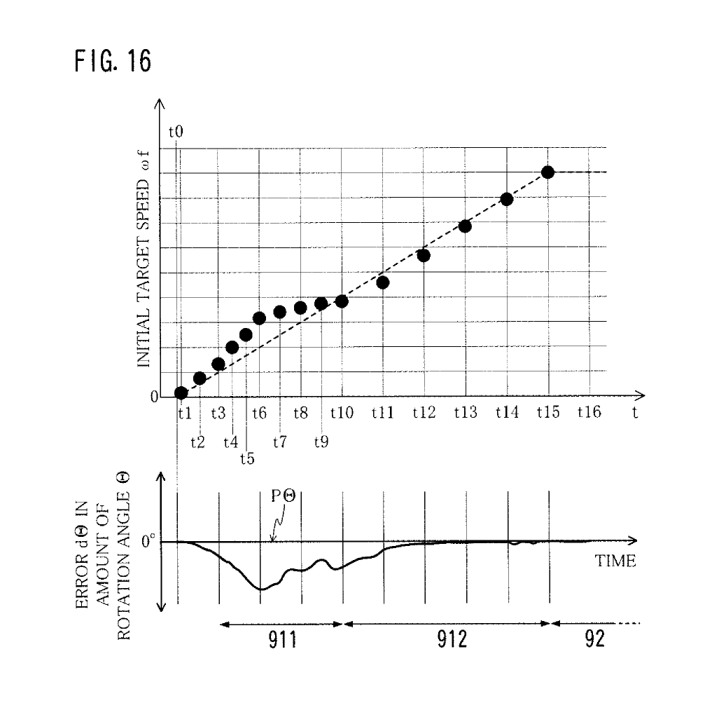

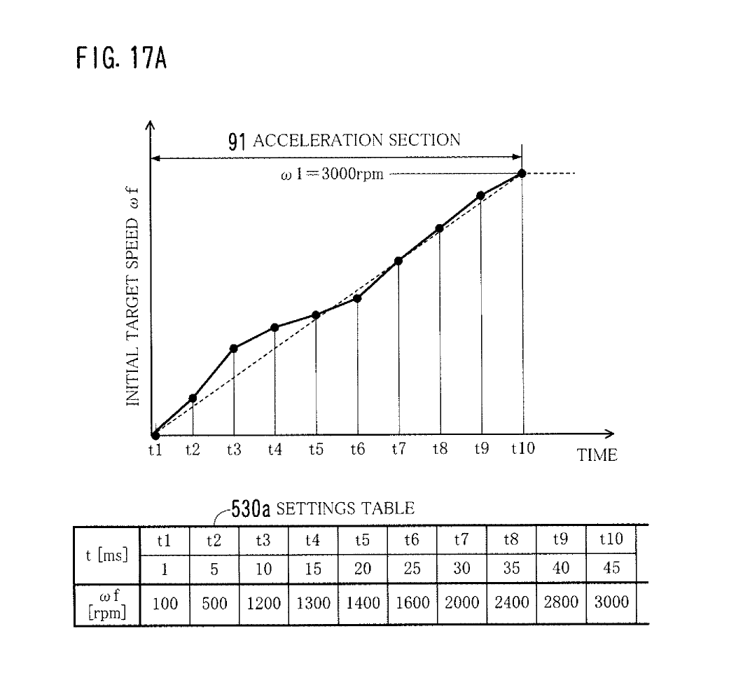

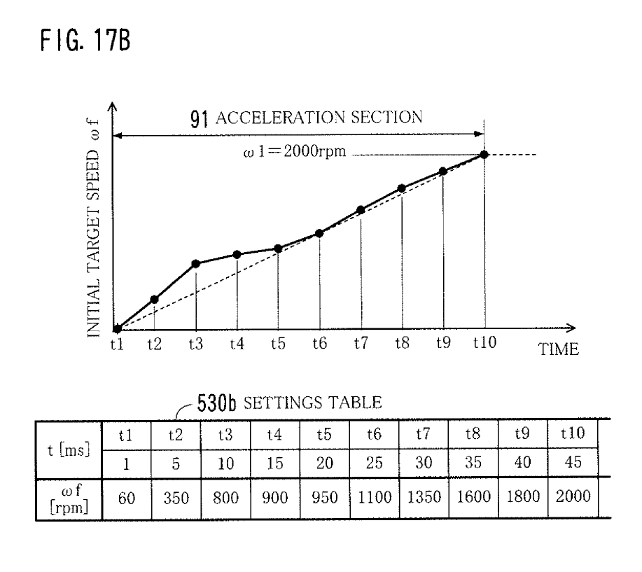

FIG. 16 shows another example as to how to set an initial target speed ωf. FIGS. 17A and 17B show examples as to how to set an initial target speed ωf for each of drive conditions.

As shown in FIG. 16, the initial target speed ωf of the control target value Dω can be set more densely in a section 911 where the amount of rotation angle Θ tends to deviate from the expected pattern PΘ than in the other sections 912 and 92.

Referring to FIGS. 17A and 17B, the settings table 530 indicating the control target values Dω is provided for each of drive conditions for the motor 3. In FIGS. 17A and 17B, the image forming apparatus 1 is assumed which changes the steady speed ω1 of the motor 3 depending on the sheet 2 to be used for printing. For example, in printing with thick paper used as the sheet 2, the steady speed ω1 is lowered in order to reduce the conveyance speed as compared to printing with normal paper used as the sheet 2.

FIGS. 17A and 17B show the settings table 530a with the steady speed ω1 set at 3000 rpm, and the settings table 530b with the steady speed ω1 set at 2000 rpm, respectively. The storage 53 of the motor controller 20 reads out the initial target speed ωf and the correction coefficient α from the corresponding settings table 530a and 530b in accordance with the change in steady speed ω1. The storage 53 then sends a control target value Dω, which is a product of the initial target speed ωf and the correction coefficient α, to the speed command portion 51 (see FIG. 10).

In the foregoing embodiment, the transition of the amount of rotation angle Θ of the motor 3 can be approximated to desired transition. The sheet 2 can be conveyed appropriately in the foregoing embodiment. It is thus possible to reduce a warp and wrinkle in the sheet 2, and a position difference between the sheet 2 and an image. Consequently, the quality of printed matters can be enhanced.

The control target value Dω is corrected at regular intervals. Thus, it is possible to optimize the transition of the amount of rotation angle Θ even if a time at which the amount of rotation angle Θ substantially deviates due to the aged deterioration of the image forming apparatus 1 or other reasons.

In the foregoing embodiments, when the upper control unit 10 outputs, to the vector control unit 21, the angle command value (position command value) θ* instead of the speed command value ω*, it is desirable to set the time-series angle command values θ* so that the amount of rotation angle Θ transitions in the same manner as the expected pattern PΘ. The time-series angle command values θ* are serially inputted to the vector control unit 21, so that the transition of the amount of rotation angle Θ can be approximated to desired transition.

In the foregoing embodiments, it is to be understood that the configuration of the image forming apparatus 1 and the motor controller 20, the constituent elements thereof, the content of the processing, the order of the processing, the time of the processing, the structure of the motor 3, and the like may be appropriately modified without departing from the spirit of the present invention.

Although embodiments of the present invention have been described and illustrated in detail, the disclosed embodiments are made for purposes of illustration and example only and not limitation. The scope of the present invention should be interpreted by terms of the appended claims.

1. A motor controller for controlling a brushless DC motor, the motor controller comprising:
a vector control unit configured to perform a sensorless vector control on the brushless DC motor in accordance with an input command value;
a storage portion configured to store time-series control target values so that an amount of rotation angle of the brushless DC motor transitions in a same manner as an expected pattern; and
a command portion configured to input, to the vector control unit, the control target values serially as the command value.

2. The motor controller according to claim 1, wherein
the control target values include, at least, control target values at acceleration from start of the brushless DC motor to a steady rotation thereof, or, alternatively, control target values at deceleration from the steady rotation of the brushless DC motor to stop thereof, and
the control target values are stored in a form of table in which each of the control target values is correlated with an order that said each of the control target values is inputted to the vector control unit.

3. The motor controller according to claim 1, further comprising
a detector configured to detect transition of the amount of rotation angle after start of the brushless DC motor, and
a correction portion configured to, when the detected transition of the amount of rotation angle deviates from the expected pattern, correct the stored control target values so that the amount of rotation angle after the start of the brushless DC motor transitions in a same manner as the expected pattern.

4. The motor controller according to claim 3, wherein the correction portion corrects the control target values every time a number of start times of the brushless DC motor exceeds a set value.

5. The motor controller according to claim 3, comprising an accumulation portion configured to accumulate data that shows the detected transition of the amount of rotation angle; wherein
the correction portion corrects the control target values based on the data accumulated.

6. The motor controller according to claim 5, wherein the accumulation portion reduces accumulation in such a manner that a number of sets of the data accumulated is smaller than a number of times that the transition of the amount of rotation angle has been detected.

7. The motor controller according to claim 1, wherein
the command value is a command value of a rotational speed of the brushless DC motor, and
the control target values are control target values for the rotational speed.

8. The motor controller according to claim 1, wherein, in a period of time during which the brushless DC motor is driven, the control target values are set more densely in a section where the amount of rotation angle tends to deviate from the expected pattern than in another section.

9. An image forming apparatus for forming an image on a sheet, the image forming apparatus comprising:
a roller configured to convey the sheet;
a brushless DC motor configured to rotationally drive the roller; and
a motor controller configured to control the brushless DC motor; wherein
the motor controller includes
a vector control unit configured to perform a sensorless vector control on the brushless DC motor in accordance with an input command value;
a storage portion configured to store time-series control target values so that an amount of rotation angle of the brushless DC motor transitions in a same manner as an expected pattern; and
a command portion configured to input, to the vector control unit, the control target values serially as the command value.

10. The image forming apparatus according to claim 9, wherein
the motor controller further includes
a detector configured to detect transition of the amount of rotation angle after start of the brushless DC motor, and
a correction portion configured to, when the detected transition of the amount of rotation angle deviates from the expected pattern, correct the stored control target values so that the amount of rotation angle after the start of the brushless DC motor transitions in a same manner as the expected pattern; wherein
the detector detects the transition of the amount of rotation angle at idle drive for rotating the brushless DC motor without conveying the sheet with the roller.

11. The motor controller according to claim 2, further comprising
a detector configured to detect transition of the amount of rotation angle after start of the brushless DC motor, and
a correction portion configured to, when the detected transition of the amount of rotation angle deviates from the expected pattern, correct the stored control target values so that the amount of rotation angle after the start of the brushless DC motor transitions in a same manner as the expected pattern.
